(19) United States
(12) Patent Application Publication
(10) Pub. No.: US 2026/0310490 A1
(43) Pub. Date: Oct. 8, 2026

(54) INVALIDATING MEMORY CONTENTS AFTER PATCHING SOFTWARE

(71) Applicant: MICROSOFT TECHNOLOGY LICENSING, LLC, Redmond, WA (US)

(72) Inventors: David Michael CALLAGHAN, Duvall, WA (US); Vijaykumar SHARMA, Sammamish, WA (US)

(21) Appl. No.: 19/251,757

(22) Filed: Jun. 26, 2025

Related U.S. Application Data
(60) Provisional application No. 63/782,566, filed on Apr. 2, 2025.

(51) Int. Cl. G06F 9/48

(52) U.S. Cl. CPC G06F 9/485; G06F 9/4881

(57) ABSTRACT

Disclosed are techniques for disabling security exploits. Some live code patches redirect execution from a vulnerable version of a function to a secure version of the function. However, the vulnerable version of the function may remain in memory, creating an opportunity for exploitation. Disclosed are techniques for determining when the vulnerable version of the function is no longer in use, and when this determination is made, rendering at least a vulnerable portion of the vulnerable version of the function inoperable. Reference counting, call stack inspection, and process lifecycle tracking may be used to determine when the vulnerable version of the function is no longer in use. Some implementations may employ compiler-assisted instrumentation, run-time generated instrumentation, or hardware support. The vulnerable version of the function may be rendered inoperable by overwriting it with illegal instructions, marking a page of memory that contains the vulnerable version of the function non-executing, etc.

### PRIORITY

This application claims the benefit of the U.S. Provisional Application Ser. No. 63/782,566 filed on Apr. 2, 2025, entitled “INVALIDATING MEMORY CONTENTS AFTER PATCHING SOFTWARE” the entirety of which is hereby incorporated by reference herein.

### BACKGROUND

Patching live code is the process of applying code changes to a running application without requiring the application or the computing device to restart. Patching is often used to apply security or stability fixes or add new functionality without disruption. For example, live code patching may dynamically replace the in-memory instructions of a function while the application continues to execute. Live code patching is not limited to just a single fix but can include an entire release of security fixes, quality improvements and new functionality. Live code patching can deliver updates to the operating system, applications and runtime environments without disrupting availability or requiring a restart of the application, framework, operating system or device. Live code patching is advantageous because it reduces downtime, improves availability, and minimizes disruption to end users and services. Furthermore, system administrators are more likely to apply security updates if they do not require restarting the application or computing device. As such, live code patches increase user adoption of security fixes, increasing the overall level of security of computing devices.

It is with respect to these and other considerations that the disclosure made herein is presented.

### SUMMARY

Disclosed are techniques for preventing security exploits from executing on a computing device, or lessening the likelihood thereof. Some live code patches redirect execution from a vulnerable version of a function to a secure version of the function. However, the vulnerable version may remain in memory, creating an opportunity for exploitation. Disclosed are techniques for determining when the vulnerable version of the function is no longer in use, and when this determination is made, rendering at least a vulnerable portion of the vulnerable version of the function inoperable. Thread reference counting, call stack inspection, and process lifecycle tracking may be used to determine when the vulnerable version of the function is no longer in use. Some implementations may employ compiler-assisted instrumentation, run-time generated instrumentation, or hardware support. The vulnerable version of the function may be rendered inoperable by overwriting it with illegal instructions, marking a page of memory that contains the vulnerable version of the function inoperable, etc.

Features and technical benefits other than those explicitly described above will be apparent from a reading of the following Detailed Description and a review of the associated drawings. This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “techniques,” for instance, may refer to system(s), method(s), computer-readable instructions, module(s), algorithms, hardware logic, and/or operation(s) as permitted by the context described above and throughout the document.

### BRIEF DESCRIPTION OF THE DRAWINGS

The Detailed Description is described with reference to the accompanying figures. In the figures, the left-most digit(s) of a reference number identifies the figure in which the reference number first appears. The same reference numbers in different figures indicate similar or identical items. References made to individual items of a plurality of items can use a reference number with a letter of a sequence of letters to refer to each individual item. Generic references to the items may use the specific reference number without the sequence of letters.

FIG. 1A illustrates an executable module that contains a function with a vulnerability.

FIG. 1B illustrates live patching the function with the vulnerability so that subsequent invocations are redirected to a revised version of the function.

FIG. 1C illustrates recursive patching-the revised version of the function is patched to forward invocations to another revised version of the function.

FIG. 2 illustrates an executable module being loaded once in physical memory but being mapped to multiple processes.

FIG. 3 illustrates call stacks of a process that indicate different ways in which a thread of execution can be dependent on an existing version of a function.

FIG. 4 illustrates an instrumented function that tracks execution entrances and exits.

FIG. 5 illustrates overwriting a portion of a function with non-executing instructions.

FIG. 6 illustrates rendering a portion of a function non-operable by setting a non-executable flag of a memory page to true.

FIGS. 7-9 illustrate process flows for invalidating memory contents after patching.

FIG. 10 is a computer architecture diagram illustrating an example computer hardware and software architecture for a computing system capable of implementing aspects of the techniques and technologies presented herein.

### DETAILED DESCRIPTION

In some configurations, a live code patch of a target function redirects calls to a patched version of the function while leaving a vulnerable portion of the target function in memory. While patching a vulnerable function generally improves the overall security posture of a computing device, some techniques for live patching can present a security risk: an attacker with sufficient knowledge of the system and privileges can invoke the vulnerable portion of the target function that continues to reside in memory. Because the vulnerable instructions remain mapped and potentially executable, the system continues to be exposed to exploits targeting known weaknesses, even after the patch has been applied. This undermines the intended security benefits of live code patching and creates an attack surface that sophisticated adversaries can exploit.

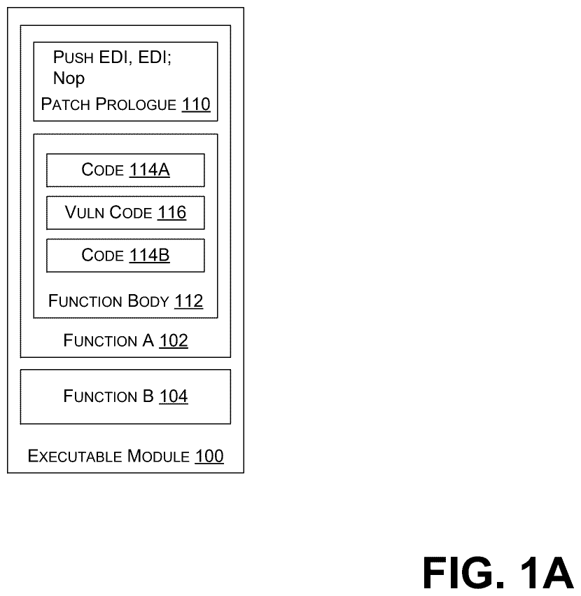

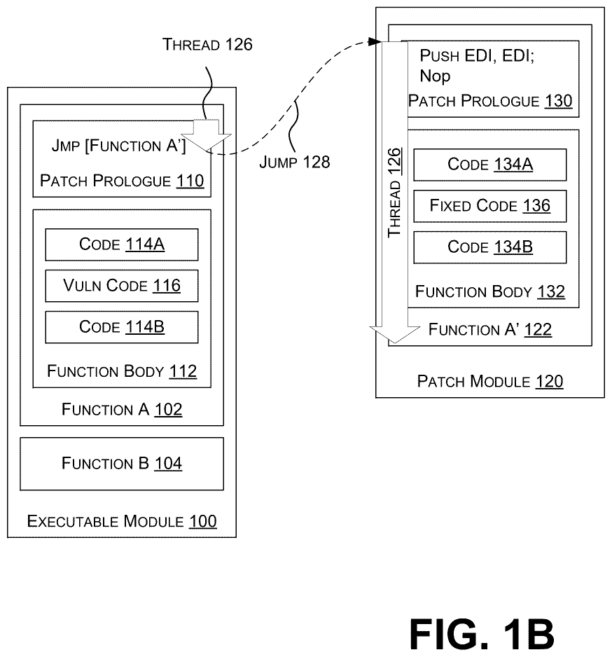

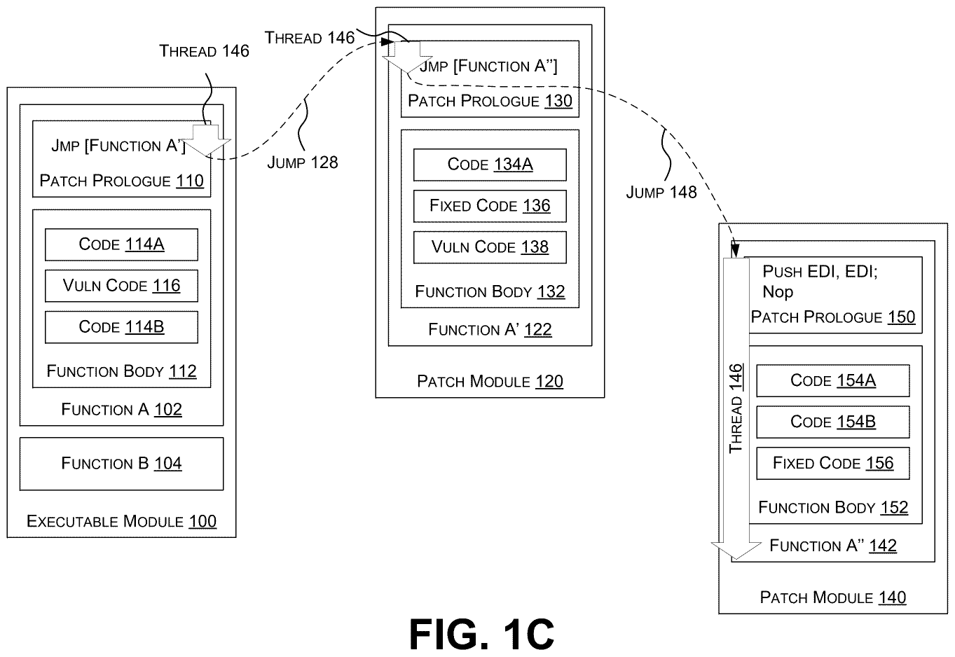

FIG. 1A illustrates a function with a code vulnerability. Function A 102 and Function B 104 are part of Executable Module 100. As referred to herein, a function is a set of executable instructions stored in memory that may receive parameters, perform tasks, invoke other functions, and return a result or status to its caller. Executable Module 100 refers to a collection of functions and data. Executable Module 100 can be loaded by an operating system. Some executable modules are executable files, such as an “.exe” file on the WINDOWS operating system or files with executable file permissions on LINUX. Some executable modules can be used concurrently by multiple applications, such as dynamically linked libraries (DLLs) on WINDOWS and shared objects (.so files) on LINUX. While the techniques disclosed herein are described in the context of WINDOWS, the disclosed techniques also apply to other operating systems including but not limited to LINUX, ANDROID, IOS, etc. Similarly, while the disclosed techniques are discussed primarily in the context of x86/x64 CPU instructions, other instruction sets of other CPUs and GPUs are similarly contemplated, such as ARM, PowerPC, etc.

Function A 102 includes Patch Prologue 110 and Function Body 112. Patch Prologue 110 is a portion of memory at the start of Function A 102 that, as compiled, consists of one or more “no-operation” instructions such as the NOP x86 instruction and/or a instructions that have no effect such as “MOV EDI, EDI”. Before a patch is applied the instructions included in Patch Prologue 110 are executed without consequence every time Function A 102 is invoked.

Patch Prologue 110 reserves space for a live code patch jump. A live code patch jump replaces at least a portion of Patch Prologue 110 with a jump instruction that redirects execution away from Function A 102. Typically, the jump instruction redirects execution to a revised version of Function A 102 or a patch handler. In this way, Function A 102 can be safely updated at runtime without modifying any of the code that invokes it. It also allows Function A 102 to be safely modified without altering the alignment or structure of Function Body 112.

A jump statement may be inserted into Patch Prologue 110 by overwriting patch prologue 110 with a jump instruction that targets the address in memory of the revised version of Function A 102. In some configurations Patch Prologue 110 appears before any instructions that initialize Function A 102. In this way, function initialization, such as allocating stack space for local variables, is deferred to the revised version of Function A 102. In many configurations the revised version of Function A 102 will have the same parameters and calling convention as Function A 102.

Function Body 112 implements the logic of Function A 102. For example, Function Body 112 may include executable instructions that perform calculations, control flow, system or library calls, and/or other useful work as part of an application's functionality.

As illustrated, Function Body 112 includes Code 114A, Vulnerable Code 116 (shown as VULN CODE 116), and Code 114B. Code 114A and 114B may hereinafter be referred to collectively as Code 114. Code 114 may refer to machine instructions that are executed by a processor at runtime, source code that is executed at runtime by an interpreter, an intermediate language that is just-in-time compiled into machine instructions before being executed, or the like. Vulnerable Code 116 refers to a portion of Function A 102 that contains a security flaw or logic error which could be exploited by an attacker. For example, Function A 102 may include a buffer overflow, use-after-free, or improper input validation vulnerability. For instance, Vulnerable Code 116 may include a portion of Function Body 112 that copies a user-supplied input into a fixed-size buffer without bounds checking. In some scenarios, it is impractical or impossible to distinguish Vulnerable Code 116 from Code 114.

FIG. 1B illustrates live code patching a function that has a code vulnerability. This is just one example of a technique for live code patching-any other method that replaces at least a portion of Function A 102 while leaving some or all of the original code of Function A 102 in memory is similarly contemplated. Furthermore, other scenarios that determine when to render code inoperable and then rendering that code inoperable are similarly contemplated, such as unloading a malicious plugin or performing a type of security disruption that removes malicious code from memory.

Patch Module 120 is an executable module that is loaded into memory. Live code patching may, for example, overwrite Patch Prologue 110 of Function A 102 with a jump instruction 128—“JMP [Function A′]”—that transfers execution directly to Function A′ 122 of Patch Module 120. Function A′ 122 may be a revised version of Function A 102 or other replacement of Function A 102. Additionally, or alternatively, Function A 102 may not include Patch Prologue 110, in which case a jump instruction may overwrite the first bytes of Function A 102.

Live code patching is typically triggered by a system resource capable of receiving and processing an update, such as WINDOWS UPDATE. This system resource may invoke the operating system, which securely determines that a patch is available based on metadata, version checks, and/or digital signatures associated with the original Executable Module 100. The update containing one or more Patch Module(s) 120 may be delivered to the operating system for performing the live code update via a network such as ethernet, Wi-Fi, Bluetooth, or loaded from storage media such as a file on a disk drive or removable storage such as USB or SD memory cards.

In addition to being used to perform a live patch, Patch Module 120 may be applied before or as Executable Module 100 is being loaded by the operating system. For example, during startup or when launching a new instance of an application, the operating system may load Executable Module 100 into memory. However, before allowing the application to begin execution, the operating system may perform the live patch by installing one or more Patch Modules 120 before any Threads 126 begin execution. When patching functions in this way Function Body 112 may be overwritten immediately, as it is known that there are no threads currently executing or scheduled to return and resume executing Function A 102.

In some operating systems, such as WINDOWS, Patch Module 120 may be distributed and applied via a DLL containing the patched function(s). Patch Module 120 is loaded into the address space of the target process, allowing invocations of Function A 102 to be forwarded efficiently to Function A′ 122. In addition to patching applications, a low-level operating system feature may install live code updates into operating system code in a similar manner.

Once Function A 102 has been patched, any thread of execution 126 that enters Function A 102 will encounter JMP instruction 128 in Patch Prologue 110 and be redirected to Function A′ 122. Function A′ 122 may include Patch Prologue 130 and Function Body 132, which are similar to Patch Prologue 110 and Function Body 112 of Function A 102. Function Body 132 includes Code 134 and Fixed Code 136, which fixes the issue of Vulnerable Code 116. While Patch Module 120 is illustrated providing a patch for Vulnerable Code 116, Patch Module 120 may provide any combination of vulnerability patching, new software feature(s), performance improvements, removal of code or features etc.

As illustrated, Thread 126 enters Function A 102 where it takes Jump Instruction 128 to Function A′ 122, where Thread 126 continues execution. This redirection bypasses the original Vulnerable Code 116 and instead executes Code 134 and Fixed Code 136 of Function A′ 122. Since the Jump instruction written to Patch Prologue 110 did not modify the call stack, any “RET” instruction encountered in Function A′ 122 will cause Thread 126 to return execution to the code that invoked Function A 102.

For example, when Function A 102 is invoked with a “CALL” instruction, the CPU pushes the return address—the memory location of the instruction to invoke once Function A 102 has completed—onto the stack. When Function A′ 122 invokes a “RET” instruction the CPU pops the return address off the stack and uses it to resume execution at the instruction that follows the invocation of Function A 102.

Thread 126 refers to a thread of execution that can be independently scheduled and executed by the operating system. Each thread 126 has its own instruction pointer, stack, and register state, but shares memory with other threads in the same process. Thus, after Function A 102 is patched, all threads that subsequently invoke Function A 102 are seamlessly and transparently redirected to Function A′ 122.

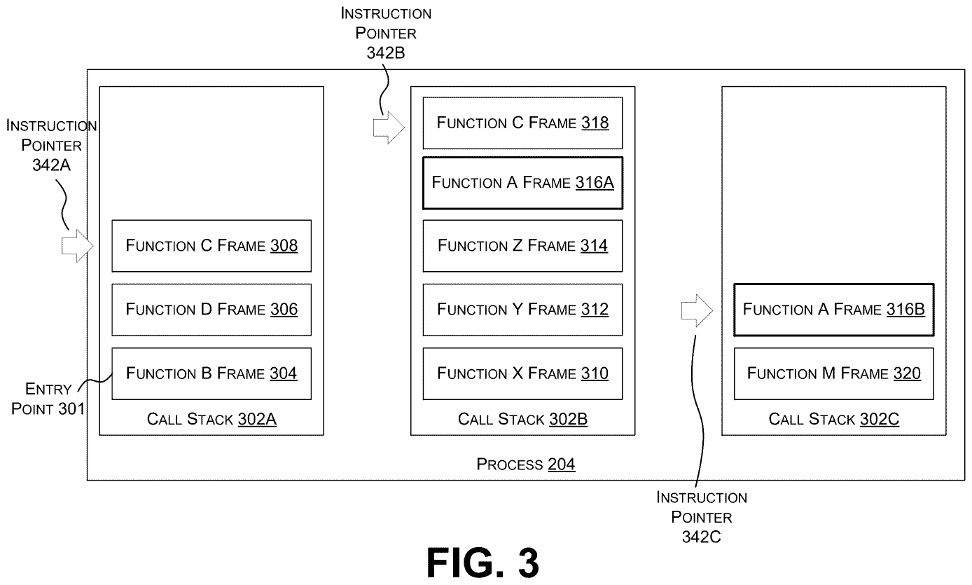

However, when patching a live application, it is not always safe to render Function Body 112 inoperable as soon as Patch Prologue 110 is overwritten with Jump 128. As discussed in more detail below in conjunction with FIG. 3, some Threads 126 may have already started executing Function A 102 and expect at least a portion of the code of Function A 102 to remain in memory and executable. For example, Function A 102 may have invoked a computationally intense sub-function that is still being processed when Patch Prologue 110 is overwritten. When complete, this sub-function will return to Function A 102. Rendering portions of Function A 102 inoperable before execution returns may lead to a crash, data loss, or a new security vulnerability.

An attacker may seek to leverage Vulnerable Code 116 after Patch Module 120 is installed. For example, an attacker may exploit Vulnerable Code 116 by jumping directly to it, bypassing jump instructions installed to Patch Prologue 110 that would otherwise redirect execution to Function A′ 122. An attacker may also redirect execution to Vulnerable Code 116 by modifying the return address of a function or by hijacking execution of a thread that still has access to Function A 102. In some environments, an attacker may overwrite Patch Prologue 110 with no-ops, such that subsequent attempt to invoke Function A 102 follows the unpatched execution path.

An attacker may seek to leverage Vulnerable Code 116 for a number of reasons. Even though it is no longer accessible through normal execution, Vulnerable Code 116 continues to contain valid machine instructions that are mapped into memory and executable. This may allow an attacker to bypass restrictions that prevent loading and execution of unauthorized code. An attacker may also seek to leverage Vulnerable Code 116 because it is already known to perform certain functionality. In many cases, patch module 120 may be released to the world with an explanation of the vulnerabilities that it corrects. While this information is useful to system administrators when determining whether to apply the patch, it also informs attackers as to the existence and functionality of the vulnerability.

In some configurations, patching Function A 102 may remove Vulnerable Code 116 from being subject to control-flow integrity systems, such as CONTROL FLOW GUARD on WINDOWS. In this scenario, when jumping to the middle of Function A 102, control-flow integrity checks may no longer be applied. This may make Vulnerable Code 116 even more vulnerable than it was before the patch was installed, as post-patch access to Vulnerable Code 116 may occur without the additional protection of the control-flow integrity system.

In some configurations, IT Administration or security compliance software success criteria requires all vulnerable code to be patched and rendered inoperable before reporting that the update is completely installed and/or the associated threats are completely mitigated. These requirements may create an incentive for system administrators to apply aspects of the disclosed embodiments.

FIG. 1C illustrates nested updates of a function: live code patching an existing live code patch. FIG. 1C is similar to FIG. 1B, except that patch module 140 is applied to an existing patch instead of an original version of a function. For example, patch module 140 may be issued in response to a security researcher determining that Code 134B itself has a security vulnerability, which may result in reconceptualizing Code 134B as Vulnerable code 138. Specifically, Patch Module 140 includes Function A″ 142, which includes Patch Prologue 150 and Function Body 152. Patch Prologue 150 is similar to Patch Prologues 110 and 130, while Function Body 152 is similar to Function Bodies 112 and 132. Function Body 152 includes Code 154, which may or may not be the same as Code 134 and/or Code 114. Function Body 152 also includes Fixed Code 156, which may partially or completely replace Vulnerable Code 138.

Patch Module 140 may be applied to Patch Module 120 in a manner similar to how Patch Module 120 is applied to Executable Module 100. For example, Patch Prologue 130 of Function A′ 122 may be overwritten with Jump Instruction 148 that redirects execution to Function A″ 142. As such, during execution, when Thread 146 begins to execute Function A 102, Jump 128 of Patch Prologue 110 causes execution to jump to Function A′ 122, at which point Jump 148 of Patch Prologue 130 causes execution to jump to Function A″ 142. From this point, Thread 146 executes Function A″ 142 before returning to the caller of Function A 102. In other configurations, applying patch module 140 entails overwriting patch prologue 110 with a jump 128 directly to Function A″ 142.

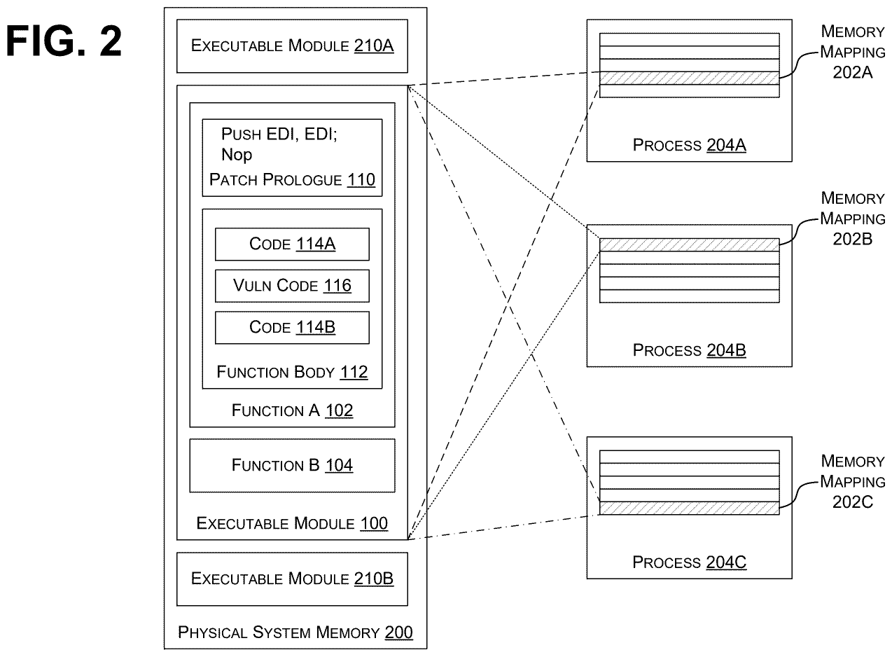

FIG. 2 illustrates an executable module that is mapped from physical memory to multiple virtual address spaces. One of the challenges to rendering Vulnerable Code 116 inoperable is ensuring that Function A 102 is no longer in use when applying Patch Module 120. If a thread has begun executing Function A 102 then it is possible that this thread will attempt to resume executing at least a portion of Function A 102. This scenario is more likely if Function A 102 is a long-running function, such as a function that performs message dispatch over the lifetime of an application. Long running functions, such as message dispatch functions or web server request handlers, may often if not always appear on a call stack, and as such will often if not always be expected to resume execution at some point in the future. Function A 102 may also run for a long period of time if it is suspended in a debugger or if it performs a computationally intense task. However, even if a function returns quickly and is rarely invoked, attempting to resume execution of Function A 102 after rendering Function Body 112 inoperable may lead to a crash, to data loss or data corruption, or result in additional security vulnerabilities.

Executable module 100 is loaded once into physical system memory 200 but mapped to multiple virtual address spaces of different system Processes 204. This illustrates how replacing Function A 102 affects more than just a single Process 204. As referred to herein, Process 204 is a layer of abstraction provided by an operating system for executing an application. Process 204 includes the state of the processor that is executing the application, such as the instruction pointer and other CPU registers. One or more threads of execution 126 may run within Process 204, each of which maintains a call stack, instruction pointers, etc. Each Process 204 runs in its own isolated virtual memory space. Processes 204 are managed by the operating system, which schedules thread execution and coordinates interactions with hardware.

Sharing Executable Module 100 across multiple processes 204 complicates determining when Function A 102 will no longer continue executing and is no longer scheduled to resume executing. In extreme cases a CPU may have multiple CPU cores running multiple instances of process 204, each of which includes multiple Threads 126 executing a code path that frequently invokes Function A 102. Function Body 112 may be safely rendered inoperable when all Threads 126 executing in all processes 204 are no longer expected to resume execution within Function A 102.

In some configurations, when Executable Module 100 is a shared object or DLL, per-process copies of Executable Module 100 may be created in physical memory. This allows in-memory changes to Executable Module 100 to be made in one process without affecting other processes. Making multiple copies of a DLL in physical memory is in contrast to the more common pattern of allowing multiple processes to concurrently access a single copy of Executable Module 100 in physical memory.

Making multiple physical copies of Executable Module 100 allows each copy of Function A 102 in each process 204 to be updated independently. This reduces the amount of time that it takes for many of the processes 204 to become independent of Function A 102, as each process 204 does not have to wait for all Threads 126 of all processes 204 to be independent of Function A 102.

In some configurations, when a live patch is applied to a particular process, and it is determined that that process is no longer dependent on Function A 102, then the process-specific Function Body 112 may be overwritten with bytes that constitute invalid instructions, non-executable instructions, or is otherwise rendered inoperable. Since this is a local copy, the changes will not affect other processes that are still executing or expected to resume execution within the original version of Function A 102.

In some configurations, Executable Module 100 is completely patched when all processes 204 have had Function Body 112 overwritten. At this point, these processes 204 may be converted back to using a single instance of Executable Module 100.

Similar to creating multiple copies of Executable Module 100 in physical memory, in some configurations a single instance of Executable Module 100 is loaded into physical memory and shared by multiple processes, but individual memory pages that contain Function A 102 are duplicated in physical memory for each process. This allows reuse of much of Executable Module 100 while still allowing Function Body 112 to be rendered inoperable on a per-process basis.

FIG. 3 illustrates analyzing call stacks of threads of execution to determine whether a vulnerable version of a function can safely be rendered inoperable. A call stack is a data structure maintained for each Thread 126 that stores information about the sequence of function calls that have led to the current state of execution. Each time a function is called, a new stack frame is pushed onto the call stack, and when a function returns, its frame is popped off the call stack. In this way, a stack frame that is below the current stack frame is said to be scheduled to resume execution.

For example, in Call Stack 302A, Function B was invoked first, and as such Function B frame 304 is at the bottom of Call Stack 302A. Function B frame 304 may have performed some other work or invoked some other functions before invoking Function D, causing Function D frame 306 to be pushed to Call Stack 302A on top of Function B frame 304. When Function D returns, Function D frame 306 will be removed from Call Stack 302A and execution will return to Function B.

Call stacks 302A, 302B, and 302C represent snapshots of the call stacks of three different Threads 126. In some configurations, when all Threads 126 are not currently executing Function A 102 and are not scheduled to resume executing Function A 102—also referred to herein as being independent of Function A 102—then it is safe to render Function Body 112 inoperable.

In some configurations, in order to make this determination, all Threads 126 within all processes 204 that have loaded Execution Module 100 are paused and their call stacks 302 are walked to determine whether any dependencies on the existing version of Function A 102 remain. Additionally, or alternatively, as discussed above in conjunction with FIG. 2, this analysis may be performed on a per-process basis.

Walking call stacks 302 to determine if any threads are still dependent on Function A 102 occurs after Jump 128 has been installed. In this way, new threads do not need to be evaluated, since any new invocation of Function A 102 will be redirected to Function A′ 122, and new threads will not have any old invocations. Similarly, any existing threads that have already been shown to be independent of Function A 102 do not need to be evaluated again, as any new invocations of Function A 102 from these existing Threads 126 will also be redirected to Function A′ 122.

A determination that even a single Thread 126 of Process 204 still depends on Function A 102 prevents Function Body 112 from being safely rendered inoperable. In order to give the remaining threads time to become independent of Function A 102, Threads 126 of process 204 may be resumed, paused, and analyzed iteratively until there are no more Threads 126 that depend on the existing version of Function A 102.

In some configurations, iteratively resuming, pausing, and analyzing Threads 126 of Process 204 may continue until a defined amount of time has passed or a defined number of pauses have occurred while the dependency on Function A 102 remains. Failure to remove a dependence on Function A 102 may indicate that Function A 102 is a long-running function. A long-running function may not be a candidate to have its Function Body 112 rendered inoperable when it is the target of a hot patch. Under these circumstances, a recommendation may be made to a system administrator that the application will need to be stopped before Function Body 112 can be rendered inoperable. In some scenarios, processes that cannot safely render Function Body 112 inoperable may be automatically restarted so that the patch can be installed before any threads begin execution, allowing Function Body 112 to be safely rendered inoperable.

In some configurations, while waiting for threads to become independent of Function A 102, a system or application configuration setting may be set that reduces how long it takes for Function A 102 to return. For example, if Function A 102 requires that internet access be enabled, internet access may be disabled, causing instances of Function A to return sooner than they otherwise would. This may reduce the amount of time it takes for Thread 126 to become independent of Function A 102.

In call stack 302A, Function B was invoked at entry point 301, as indicated by Function B Frame 304. Function B invoked Function D, as indicated by Function D Frame 306, which in turn invoked Function C as indicated by Function C Frame 308. The current instruction pointer 342A points to an instruction within Function C, indicating the thread is currently executing a portion of Function C. When Function C returns, execution will resume in Function D. Similarly, when Function D returns, execution will resume in Function B. Call Stack 302A represents a snapshot of the sequence of function calls that have led to the current point of execution, but other calls to and returns from other functions may occur before or after the invocations indicated by Call Stack 302A. Call Stack 302A is not invoking, nor will it necessarily return to and continue invoking Function A 102, and so Call Stack 302A indicates that the corresponding thread does not have a dependency on Function A 102 at this point in time.

In call stack 302B, the thread began in Function X as indicated by Function X Frame 310, which called Function Y as indicated by Function Y Frame 312, which called Function Z as indicated by Function Z Frame 314, then Function A 102 as indicated by Function A Frame 316A, and finally Function C as indicated by Function C Frame 318. Instruction pointer 342B indicates that Function C is currently executing. At first it may seem that this thread is independent of Function A 102, since execution is currently elsewhere. However, Call Stack 302B indicates that execution is scheduled to return from Function C to Function A 102, and so rendering the existing version of Function A 102 inoperable as part of a live code patch operation could cause the thread to crash.

In call stack 302C, Function M 320 called Function A 102 as indicated by Function M Frame 320 appearing beneath Function A Frame 316B, and instruction pointer 342C indicates that execution is currently within Function A 102. Call Stack 302C indicates that Function A 102 is currently being executed, and so it is not safe to render Function Body 112 inoperable.

In some configurations an analysis of Function Body 112 may indicate that a portion of Function Body 112 is unreachable by the threads that are still dependent on Function A 102. For example, Function Body 112 may be disassembled and subject to a code-flow analysis to identify portions that are unreachable based on where the threads with dependencies are executing or scheduled to resume execution. Any unreachable portions of Function Body 112 may be safely overwritten or otherwise rendered inoperable. It may not be known whether Vulnerable Code 116 was contained in one of these unreachable portions of Function Body 112, but rendering them inoperable reduces the likelihood that Vulnerable Code 116 will be exploited.

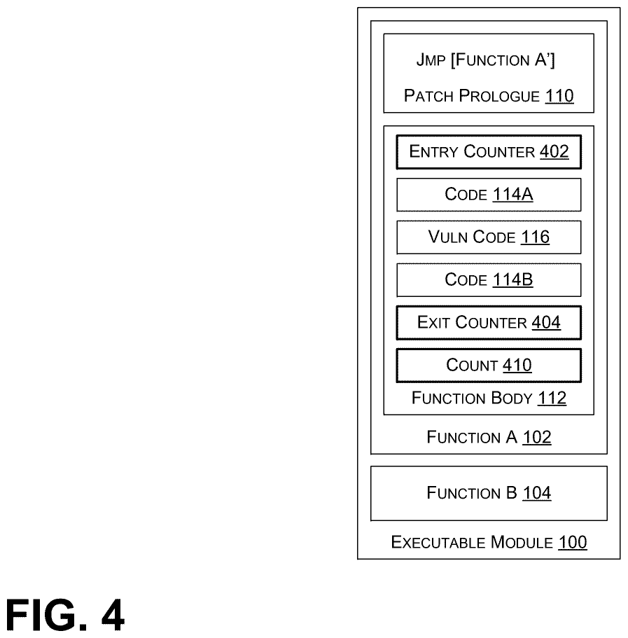

FIG. 4 illustrates a function that, as deployed, or as modified, counts how many threads are currently executing within that function. In FIG. 4, Function Body 112 of Function A 102 has been instrumented to maintain Count 410 of how many Threads 126 are executing within Function A 102. Entry Counter 402 may be implemented as executable code placed at the beginning of Function Body 112 that increments Count 410 each time a thread enters Function A 102. In some configurations, Entry Counter 402 is inserted into a patch prologue of Function A′ 122. Similarly, Exit Counter 404 may be executable code placed before any instruction of Function A 102 that causes execution to leave Function A 102. Exit Counter 404 decrements Count 410.

Functions typically begin executing at a specific address, often stored in function pointers. However, it is possible for an execution to jump to any address within a function. While rare, these other entry points may be identified by a compiler that compiles Executable Module 100 and thereby has visibility into how Function A 102 may be invoked. The compiler may emit additional instances of Entry Counter 402 at these locations. In some configurations, the compiler may emit additional control flow instructions to ensure that code paths within Function A 102 do not invoke multiple Entry Counters 402. For example, the compiler may place Entry Counters 402 at jump targets that originate from outside of Function A 102. At the same time, the compiler may add local jump instructions to ensure that code flows within Function A 102 skip over all but one of these Entry Counters 402. In some configurations, these additional Entry Counters 402 may be inserted dynamically at run-time, such as when attempting to patch Function A 102.

Functions typically exit by invoking the “RET” instruction or equivalent. However, there are other less common ways of returning from a function, including “JMP” and “SYSRET” instructions, operating system calls that terminate the process, exception handling blocks, etc. Multiple copies of Exit Counter 404 may be placed throughout Function A 102 before instructions that leave Function A 102. These Exit Counters 404 may be inserted by a compiler when generating Function A 102 or by modifying Function A 102 on disk or in memory at runtime.

In some configurations, instead of having copies of Exit Counter 404 being placed throughout Function A 102, Exit Counter 404 may be stored once in memory and jumped to by individual “JMP” instructions placed before instructions that cause execution to leave Function A 102.

Additionally, or alternatively, Exit Counter 404 may be invoked by modifying the return address on the stack to point to Exit Counter 404. In some configurations, Entrance Counter 402 performs this modification. Ordinarily, the return address on the stack points to an instruction to execute once Function A 102 returns. This original return address may be saved before modifying the return address. At the same time, Exit Counter 404 may be configured to invoke the original return address once Count 410 has been decremented. In this way, no matter how Function A 102 returns or where Function A 102 returns from, Exit Counter 404 will be executed in lieu of the code at the return address, after which execution will jump to the original return address.

Entry Counter 402 and Exit Counter 404 may be implemented in a number of ways. For example, a CRITICAL_SECTION or other mutual exclusion mechanism may be used to serialize access to Count 410. Additionally, or alternatively, atomic operations such as interlocked increment and interlocked decrement may be used to modify Count 410 in a thread-safe manner.

In other embodiments the reference counting of Function A 102 can be implemented using thread local storage (TLS). For example, on the WINDOWS operating system functions such as TlsAlloc, TlsSetValue, and TlsGetValue may be used to store a per-thread Count 410. A separate mechanism such as a global aggregator may be used to aggregate the per-thread Counts 410. Per-thread tracking avoids locking and has the added benefit of tracking individual thread activity.

In some configurations, Count 410 being greater than zero indicates that there is at least one Thread 126 currently executing within Function A 102 or that will return to executing within Function A 102. When Count 410 is zero, then no Threads 126 of the current Process 204 are executing within or will return to executing within Function A 102. As such, it is safe to render at least a portion of Function Body 112 inoperable when Count 410 equals zero.

Entry Counter 402 and Exit Counter 404 may be inserted in a variety of ways. In some configurations, a compiler used to generate Function A 102 may emit Entry Counter 402, Exit Counter 404, and Count 410 when generating machine instructions that constitute Function A 102. In this embodiment, the instrumentation code may be executed each time Function A 102 is executed.

In some configurations, in addition to or instead of maintaining Count 410 for each function, Entry Counter 402 and/or Exit Counter 404 may record timestamps of entry into Function A 102 and exit from Function A 102. Timestamps of entry may be recorded on a per-thread basis, e.g., along with a thread identifier. A time at which the live code patch was installed may also be recorded. Comparing the time at which the live code patch was installed with timestamps of thread entry to and exit from Function A 102 enables the system to determine if any invocations of Function A 102 predate the live code patch. If an invocation of Function A 102 does predate the live code patch then it may expect to resume execution within Function Body 112, in which case it is not yet safe to render Vulnerable Code 116 inoperable.

In some configurations, instead of installing or activating Entry Counter 402 and Exit Counter 404, operating system telemetry may be activated to track entry into and exit from Function A 102. For example, perf counters or debug hooks may be activated to track entry into and exit from Function A 102.

Additionally, or alternatively, special purpose hardware may be employed to track thread entry and exit from Function A 102. For example, a special CPU feature may track thread entry into and return from some or all functions. Additionally, or alternatively, a special CPU feature may list the addresses of functions that have been called by particular threads. Capturing this information using purpose-built hardware features may significantly reduce the computational and memory overhead of instrumenting functions to determine whether Thread 126 still depends on Function A 102.

In some configurations, Function A′ 122 of Patch Module 120 may be applied when Executable Module 100 is loaded for the first time since the computing device restarted or since all applications that load Executable Module 100 have exited. In this way, the operating system may load and apply Patch Module 120 before any user threads enter Function A 102. As such, there is no concern over existing threads having entered Function A 102 or being scheduled to return to Function A 102. In this scenario, Function Body 112 may be rendered inoperable without installing Entry Counter 402 or Exit Counter 404. Similarly, Function Body 112 may be rendered inoperable without walking call stacks of active threads as discussed above in conjunction with FIG. 3 or otherwise determining whether any threads still depend on Function A 102.

In some configurations multiple techniques may be used, separately or in conjunction with each other, to determine when it is safe to render Function Body 112 non-operable. One technique is to enumerate the running Processes 300 and/or Threads 126 of the host computing device. Threads 126 and Processes 300 may be enumerated with system functions and stored in a first list of potentially dependent Threads 126. Then, periodically, another list of Processes 300 and/or Threads 126 may be enumerated and compared to the first list. If all of the Threads 126 and/or all of the Processes 300 that were originally identified are no longer in existence, then it is known that no threads remain within or will return to Function A 102, and so Function Body 112 can be rendered inoperable.

This technique may be applied with or without Entry Counter 402 and Exit Counter 404 and with or without analyzing call stacks as discussed above in conjunction with FIG. 3. In some configurations, Threads 126 may be removed from the first list when another technique determines that they are no longer dependent on Function A 102. For example, an Exit Counter 404 may be executed, causing a Count 410 to reduce to zero, indicating that the particular Thread 126 is no longer dependent on Function A 102, and as such may be removed from the first list.

In some configurations a resilient system design may not need Entry Counter 402, Exit Counter 404, and Count 410. When an application is resilient it tracks which tasks are currently being performed and which tasks have been completed. When a crash occurs while a task is being performed, a resilient system restarts the processing of this task. As such, in a resilient system, rendering Function Body 112 inoperable after applying Patch Module 120 may cause a crash. However, the resilient system may restart the task that was being performed, and so there is little to no negative consequence for causing the crash.

Some high-reliability systems in mainframes or fault-tolerant CPUs implement checkpointing. Checkpointing allows a computing device to return to a state it was in at a previous point in time. In these systems the checkpoint capability may be used to obviate any errors encountered by prematurely rendering Function Body 112 inoperable. For example, the system may be rolled back to a checkpoint, patched, and allowed to resume execution.

In some configurations, Function Body 112 is rendered inoperable indirectly by replacing Executable Module 100 on disk with an updated version that includes Function Body 132 to the exclusion of Function Body 112. As such, the updated version of Executable Module 100 does not contain Vulnerable Code 116. This ‘V2’ of Executable Module 100 may be generated dynamically by making a copy of Executable Module 100, except that Function Body 112 is replaced with Function Body 132. Alternatively, the ‘V2’ of Executable Module 100 may be downloaded from an official repository. However it is acquired, the ‘V2’ of Executable Module 100 may be loaded before any threads have been created, such as when Executable Module 100 is asked to be loaded after process restart or a system reboot.

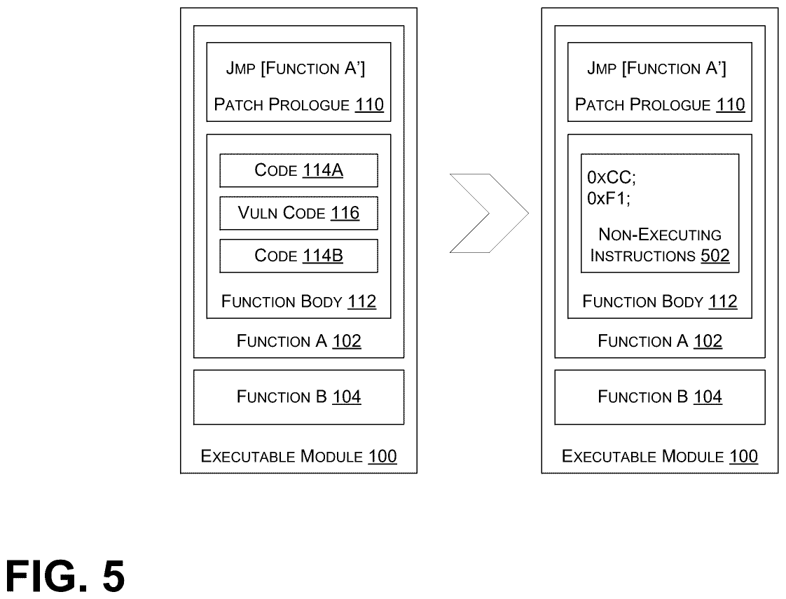

FIG. 5 illustrates overwriting a vulnerable portion of a vulnerable function with non-executing instructions. This is one technique for rendering Vulnerable Code 116 inoperable. For example, Vulnerable Code 116 may be overwritten with Non-Executing Instructions 502, which include but are not limited to: a breakpoint instruction, such as ‘0xCC’ or ‘0xF1’ on an x64 architecture CPU, or any other instructions that halt execution. In some cases it is not possible to distinguish Vulnerable Code 116 from other Code 114 of Function Body 112. In this case, Function Body 112 may be substantially or completely overwritten with Non-Executing instructions 502. In addition to rendering the vulnerability inoperable, overwriting Vulnerable Code 116 also makes it more difficult for an attacker to copy Vulnerable Code 116 for deployment elsewhere. It also makes it more difficult for an attacker to reverse-engineer or otherwise analyze Vulnerable Code 116.

In some configurations, in addition to or instead of patching Function A 102 such that execution redirects to Function A′ 122, non-Executing Instructions 502 are selected to raise an exception that is handled by a thread exception handler. The thread exception handler may then redirect execution to Function A′ 122. Additionally, or alternatively, the thread exception handler may alert a system administrator that an unexpected attempt was made to execute code that has been replaced with a hot patch. In some configurations, a disruption—an action taken to mitigate a security threat—is taken in response to receiving an indication of an exception thrown from the overwritten portion of Function A 102. For example, the application that includes Function A 102 may be paused or terminated in response to detecting that an attempt was made to execute code that has been replaced by a hot patch.

Vulnerable Code 116 may be overwritten with other types of instructions, such as no-op instructions similar to the instructions that compilers use for patch prologues. In some configurations, some or all of Function Body 112 may be overwritten with instructions that alert the application or the operating system that a cyberattack is being attempted, such as by invoking an operating system security API, allowing for additional security measures to be taken.

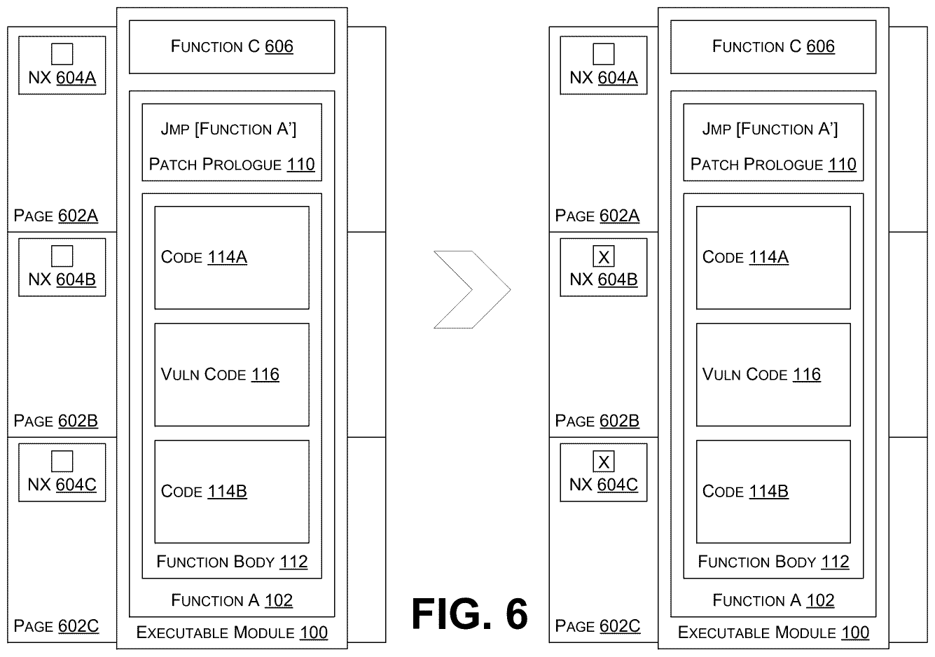

FIG. 6 illustrates marking virtual memory pages that store at least a vulnerable portion of a vulnerable function as non-executing. In some scenarios it is undesirable or impossible to modify Function Body 112 as described above in conjunction with FIG. 5. As such, another technique for rendering Vulnerable Code 116 inoperable is to mark some or all of the memory pages in which Function Body 112 resides as “non-executable”, such as by setting the “NX” bit of memory pages to true on the x64 architecture.

A memory page is a fixed-size block of virtual memory, typically 4KB or 8KB in size. Operating systems manage memory in units of pages, mapping them between virtual memory used by processes 204 and physical memory. Pages can have different attributes, such as read/write permissions or executable status, and can be swapped in and out of disk storage to optimize memory usage. Once an NX bit 604 is set to true, the computing device will not allow code stored in the corresponding page 602 to be executed.

In some configurations the NX bit 604 of a memory page is not set to true if doing so would affect other functions. As illustrated, Page 602A stores at least a portion of Function C 606, and so corresponding NX Bit 604A is not set to true in order to avoid rendering Function C 606 inoperable. NX Bits 604 may also be left false when the corresponding Page 602 contains Patch Prologue 110 or other portion of Function A 102 that is necessary to forward execution to a live code patch.

In some configurations, when compiling Function A 102, a setting may be activated that prevents a single code page from containing executable code from two different functions. This reduces the chance that a code page is prevented from being marked as non-executable due to the presence of other functions. Additionally, or alternatively, Function A 102 may be compiled such that Patch Prologue 110 is stored on one page while Function Body 112 is stored on another page. In this way, the one or more Pages 602 that store Function Body 112 may be marked as non-executable without affecting Patch Prologue 110. In some configurations, code from Function Body 112 that cannot be marked inoperable using NX bit 604 may be rendered inoperable in other ways, such as by overwriting memory as discussed above in conjunction with FIG. 5.

As illustrated, Function Body 112, which contains Vulnerable Code 116, is stored across multiple memory pages 602A, 602B, and 602C. Only pages 602B and 602C can be marked as non-executable without affecting surrounding functions or code used to forward execution to a live code patch. Accordingly, NX Bits 604B and 604C are set to true, preventing them from being executed.

In addition to or as an alternative to NX Bits 604, operating system code integrity features may also be used to prevent invocation of Vulnerable Code 116. In some configurations, at least Vulnerable Code 116 of Function A 102 is identified for protection by a code integrity feature such as WINDOWS CONTROL FLOW GUARD. In some scenarios, Vulnerable Code 116 may not be distinguished from Code 114, in which case the entire Function Body 112 may be identified for protection. In some configurations, code integrity systems may be configured to treat Function A 102 and Function A′ 122—the live code patch—as a combined unit of code.

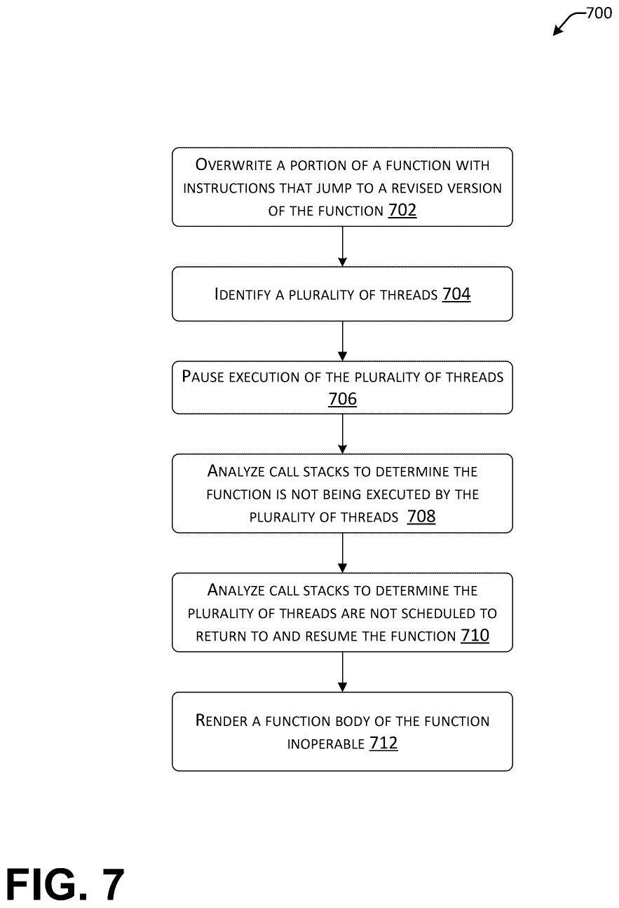

With reference to FIG. 7, routine 700 begins at operation 702, where Patch Prologue 110 of Function A 102 is overwritten with Jump Instruction 128 that redirects execution to Function A′ 122.

Next at operation 704, a plurality of Threads 126 are identified within a plurality of processes 300.

Next at operation 706, execution of the plurality of Threads 126 is paused.

Next at operation 708, Call Stacks 302 of the plurality of Threads 126 are analyzed to determine that Function A 102 is not being executed by the plurality of Threads 126.

Next at operation 710, Call Stacks 302 of the plurality of Threads 126 are analyzed to determine that Function A 102 is not scheduled to be returned to and execution resumed by the plurality of Threads 126.

Next at operation 712, Function body 112 of Function A 102 is rendered inoperable.

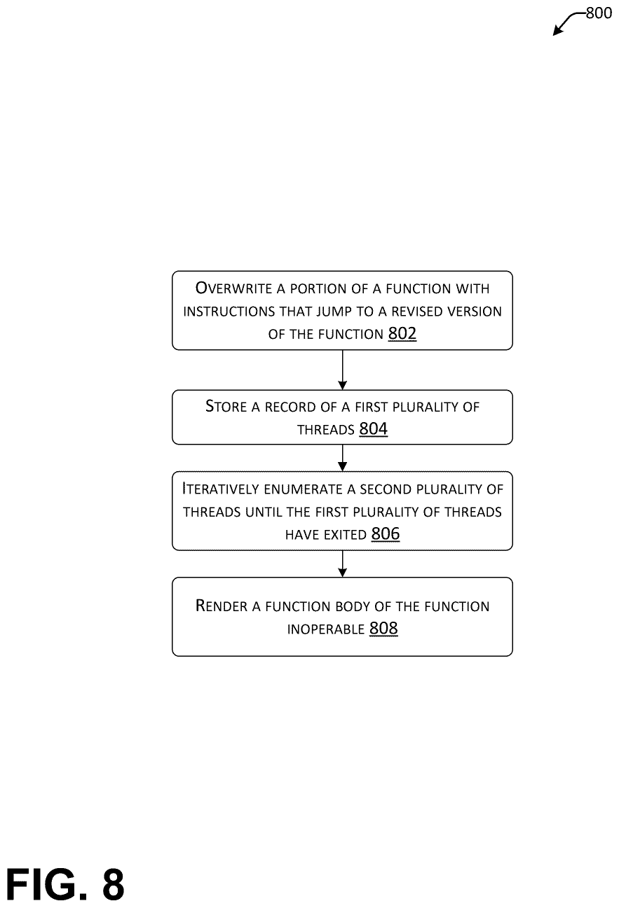

With reference to FIG. 8, routine 800 begins at operation 802, where Patch Prologue 110 of Function A 102 is overwritten with Jump Instruction 128 that redirects execution to Function A′ 122.

Next at operation 804, a record of a first plurality of Threads 126 executing within a plurality of Processes 300 is stored.

Next at operation 806, a second plurality of Threads 126 is iteratively enumerated until the first plurality of Threads 126 have exited.

Next at operation 808, Function body 112 of Function A 102 is rendered inoperable.

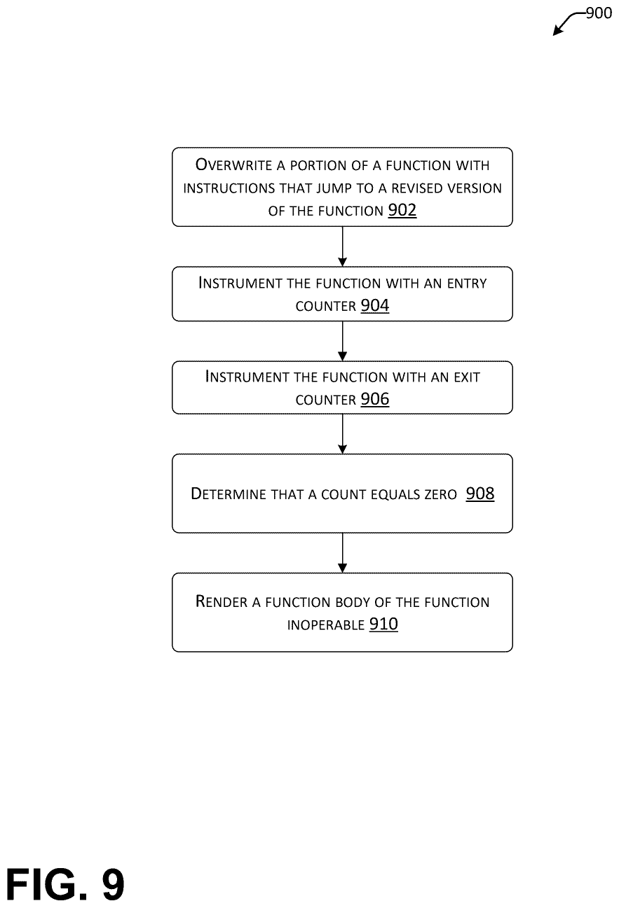

With reference to FIG. 9, routine 900 begins at operation 902, where Patch Prologue 110 of Function A 102 is overwritten with Jump Instruction 128 that redirects execution to Function A′ 122.

Next at operation 904, Function A 102 is instrumented with Entry Counter 402 at least at an entry point of Function A 102.

Next at operation 906, Function A 102 is instrumented with Exit Counter 404 before instructions that cause Function A 102 to return.

Next at operation 908, a determination is made whether Count 410 is zero.

Next at operation 910, Function body 112 of Function A 102 is rendered inoperable.

The particular implementation of the technologies disclosed herein is a matter of choice dependent on the performance and other requirements of a computing device. Accordingly, the logical operations described herein are referred to variously as states, operations, structural devices, acts, or modules. These states, operations, structural devices, acts, and modules can be implemented in hardware, software, firmware, in special-purpose digital logic, and any combination thereof. It should be appreciated that more or fewer operations can be performed than shown in the figures and described herein. These operations can also be performed in a different order than those described herein.

It also should be understood that the illustrated methods can end at any time and need not be performed in their entireties. Some or all operations of the methods, and/or substantially equivalent operations, can be performed by execution of computer-readable instructions included on a computer-storage media, as defined below. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts, and modules may be implemented in software, in firmware, in special purpose digital logic, and any combination thereof.

For example, the operations of the routine 700 are described herein as being implemented, at least in part, by modules running the features disclosed herein can be a dynamically linked library (DLL), a statically linked library, functionality produced by an application programing interface (API), a compiled program, an interpreted program, a script or any other executable set of instructions. Data can be stored in a data structure in one or more memory components. Data can be retrieved from the data structure by addressing links or references to the data structure.

Although the following illustration refers to the components of the figures, it should be appreciated that the operations of the routines 700, 800, and 900 may be also implemented in many other ways. For example, the routines 700, 800, and 900 may be implemented, at least in part, by a processor of another remote computer or a local circuit. In addition, one or more of the operations of the routines 700, 800, and 900 may alternatively or additionally be implemented, at least in part, by a chipset working alone or in conjunction with other software modules. In the example described below, one or more modules of a computing system can receive and/or process the data disclosed herein. Any service, circuit or application suitable for providing the techniques disclosed herein can be used in operations described herein.

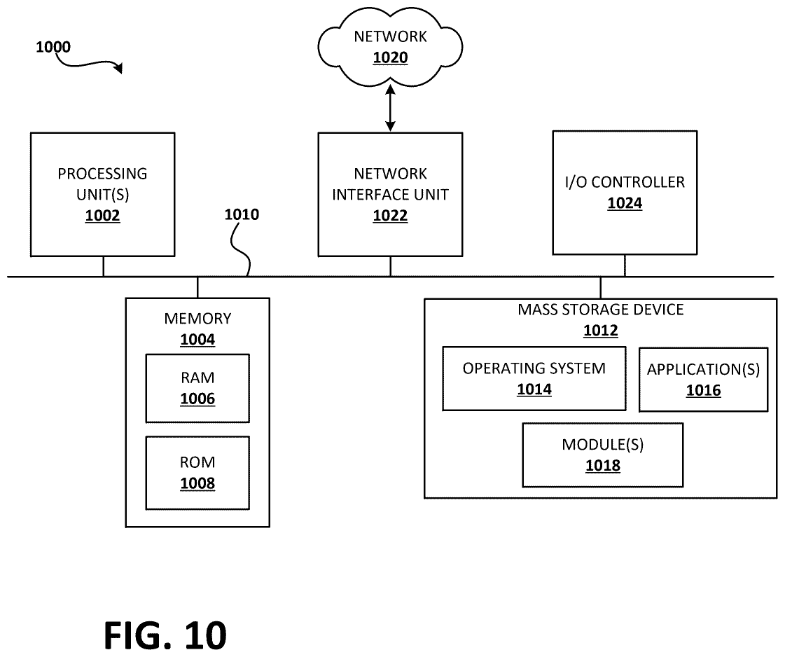

FIG. 10 shows additional details of an example computer architecture 1000 for a device, such as a computer or a server configured as part of the systems described herein, capable of executing computer instructions (e.g., a module or a program component described herein). The computer architecture 1000 illustrated in FIG. 10 includes processing unit(s) 1002, a system memory 1004, including a random-access memory 1006 (“RAM”) and a read-only memory (“ROM”) 1008, and a system bus 1010 that couples the memory 1004 to the processing unit(s) 1002.

Processing unit(s), such as processing unit(s) 1002, can represent, for example, a CPU-type processing unit, a GPU-type processing unit, a neural processing unit, a field-programmable gate array (FPGA), another class of digital signal processor (DSP), or other hardware logic components that may, in some instances, be driven by a CPU. For example, and without limitation, illustrative types of hardware logic components that can be used include Application-Specific Integrated Circuits (ASICs), Application-Specific Standard Products (ASSPs), System-on-a-Chip Systems (SOCs), Complex Programmable Logic Devices (CPLDs), etc.

A basic input/output system containing the basic routines that help to transfer information between elements within the computer architecture 1000, such as during startup, is stored in the ROM 1008. The computer architecture 1000 further includes a mass storage device 1012 for storing an operating system 1014, application(s) 1016, modules 1018, and other data described herein.

The mass storage device 1012 is connected to processing unit(s) 1002 through a mass storage controller connected to the bus 1010. The mass storage device 1012 and its associated computer-readable media provide non-volatile storage for the computer architecture 1000. Although the description of computer-readable media contained herein refers to a mass storage device, it should be appreciated by those skilled in the art that computer-readable media can be any available computer-readable storage media or communication media that can be accessed by the computer architecture 1000.

Computer-readable media can include computer-readable storage media and/or communication media. Computer-readable storage media can include one or more of volatile memory, nonvolatile memory, and/or other persistent and/or auxiliary computer storage media, removable and non-removable computer storage media implemented in any method or technology for storage of information such as computer-readable instructions, data structures, program modules, or other data. Thus, computer storage media includes tangible and/or physical forms of media included in a device and/or hardware component that is part of a device or external to a device, including but not limited to random access memory (RAM), static random-access memory (SRAM), dynamic random-access memory (DRAM), phase change memory (PCM), read-only memory (ROM), erasable programmable read-only memory (EPROM), electrically erasable programmable read-only memory (EEPROM), flash memory, compact disc read-only memory (CD-ROM), digital versatile disks (DVDs), optical cards or other optical storage media, magnetic cassettes, magnetic tape, magnetic disk storage, magnetic cards or other magnetic storage devices or media, solid-state memory devices, storage arrays, network attached storage, storage area networks, hosted computer storage or any other storage memory, storage device, and/or storage medium that can be used to store and maintain information for access by a computing device.

In contrast to computer-readable storage media, communication media can embody computer-readable instructions, data structures, program modules, or other data in a modulated data signal, such as a carrier wave, or other transmission mechanism. As defined herein, computer storage media does not include communication media. That is, computer-readable storage media does not include communications media consisting solely of a modulated data signal, a carrier wave, or a propagated signal, per se.

According to various configurations, the computer architecture 1000 may operate in a networked environment using logical connections to remote computers through the network 1020. The computer architecture 1000 may connect to the network 1020 through a network interface unit 1022 connected to the bus 1010. The computer architecture 1000 also may include an input/output controller 1024 for receiving and processing input from a number of other devices, including a keyboard, mouse, touch, or electronic stylus or pen. Similarly, the input/output controller 1024 may provide output to a display screen, a printer, or other type of output device.

It should be appreciated that the software components described herein may, when loaded into the processing unit(s) 1002 and executed, transform the processing unit(s) 1002 and the overall computer architecture 1000 from a general-purpose computing system into a special-purpose computing system customized to facilitate the functionality presented herein. The processing unit(s) 1002 may be constructed from any number of transistors or other discrete circuit elements, which may individually or collectively assume any number of states. More specifically, the processing unit(s) 1002 may operate as a finite-state machine, in response to executable instructions contained within the software modules disclosed herein. These computer-executable instructions may transform the processing unit(s) 1002 by specifying how the processing unit(s) 1002 transition between states, thereby transforming the transistors or other discrete hardware elements constituting the processing unit(s) 1002.

The present disclosure is supplemented by the following example clauses:

### Example 1

A method comprising: overwriting a portion of a function with instructions that redirect execution to a revised version of the function, wherein the function is included in an executable module ; identifying a plurality of threads executing within a process that has loaded the executable module ; pausing execution of the plurality of threads ; analyzing a plurality of call stacks of the plurality of threads to determine that the function is not being executed by the plurality of threads ; analyzing the plurality of call stacks of the plurality of threads to determine that the plurality of threads are not scheduled to return to and resume execution of the function ; and rendering a function body of the function inoperable.

### Example 2

The method of example 1, wherein the plurality of threads are iteratively paused and the plurality of call stacks are iteratively analyzed until the plurality of threads have returned from the function and the plurality of threads are no longer scheduled to return to and resume execution of the function.

### Example 3

The method of example 2, wherein a thread of the plurality of threads that has returned from the function and that no longer is scheduled to return to and execute within the function is removed from the plurality of threads.

### Example 4

The method of example 1, wherein the executable module is shared by a plurality of processes, the method further comprising: making a copy of the executable module in physical memory that is accessible to one of the plurality of processes, wherein rendering the function body inoperable comprises rendering the function body inoperable in the copy of the executable module.

### Example 5

The method of example 1, wherein the executable module is shared by a plurality of processes, the method further comprising: making a copy of a page of memory of the function body in physical memory that is accessible to one of the plurality of processes, wherein rendering the function body inoperable comprises rendering the page of memory inoperable.

### Example 6

The method of example 1, wherein determining that one of the plurality of threads is scheduled to return to and resume execution of the function by identifying a stack frame of the function that is underneath a top stack frame.

### Example 7

The method of example 1, wherein the plurality of threads are identified from a plurality of processes.

### Example 8

The method of example 1, further comprising: identifying a plurality of dependent threads of the plurality of threads that are executing or are scheduled to return to and resume executing the function; identifying a portion of the function body that is unreachable by the plurality of dependent threads; and rendering the portion of the function body inoperable.

### Example 9

The method of example 1, wherein the plurality of threads are iteratively paused and the plurality of call stacks are iteratively analyzed until a defined period of time or a defined number of pauses have occurred.

### Example 10

The method of example 9, further comprising: sending an alert indicating that vulnerable code of a patched function could not be safely rendered inoperable.

### Example 11

A system comprising: a processing unit; and a computer-readable storage medium having computer-executable instructions stored thereupon that, when executed by the processing unit, cause the processing unit to: overwrite a portion of a function with instructions that redirect execution to a patched version of the function ; store a record of a first plurality of threads executing within a first plurality of processes that have loaded the function ; iteratively enumerate a second plurality of threads executing within the first plurality of processes that have loaded the function until the first plurality of threads have exited or the first plurality of processes have exited; and render at least a portion of a function body of the function inoperable.

### Example 12

The system of example 11, wherein new invocations of the function are redirected to the patched version of the function.

### Example 13

The system of example 11, wherein the computer-executable instructions further cause the processing unit to: identify a feature of an application or operating system that causes the function to remain active; and disabling the feature.

### Example 14

A computer-readable storage device having encoded thereon computer-readable instructions that when executed by a processing unit causes a system to: overwrite a portion of a function with instructions that redirect execution to a revised version of the function, wherein the function is instrumented with: an entry counter that increments a count when a thread enters the function ; an exit counter that decrements the count when the thread exits the function ; determine that the count equals zero; and render a function body of the function inoperable.

### Example 15

The computer-readable storage device of example 14, wherein the function is instrumented by a compiler of the function by inserting the entry counter at an entry point of the function and inserting the exit counter before an instruction that exits the function.

### Example 16

The computer-readable storage device of example 14, wherein the function is instrumented with the entrance counter at runtime by placing a pointer to the entrance counter in a patch prologue of the revised version of the function, and wherein the function is instrumented with the exit counter at runtime by, for each invocation of the function, overwriting a return address with a pointer to the exit counter.

### Example 17

The computer-readable storage device of example 14, wherein the function body is rendered inoperable by overwriting the function body with no-operation instructions.

### Example 18

The computer-readable storage device of example 14, wherein the function body is rendered inoperable by overwriting the function body with instructions that throw an exception.

### Example 19

The computer-readable storage device of example 18, wherein the computer-readable instructions further cause the processing unit to: detect an exception thrown by an instruction written to the function body; and apply a security disruption operation to an application associated with the plurality of threads.

### Example 20

The computer-readable storage device of example 14, wherein the function body is rendered inoperable by marking at least one page of memory that stores the function body as non-executable.

While certain example embodiments have been described, these embodiments have been presented by way of example only and are not intended to limit the scope of the inventions disclosed herein. Thus, nothing in the foregoing description is intended to imply that any particular feature, characteristic, step, module, or block is necessary or indispensable. Indeed, the novel methods and systems described herein may be embodied in a variety of other forms; furthermore, various omissions, substitutions and changes in the form of the methods and systems described herein may be made without departing from the spirit of the inventions disclosed herein. The accompanying claims and their equivalents are intended to cover such forms or modifications as would fall within the scope and spirit of certain of the inventions disclosed herein.

It should be appreciated that any reference to “first,” “second,” etc. elements within the Summary and/or Detailed Description is not intended to and should not be construed to necessarily correspond to any reference of “first,” “second,” etc. elements of the claims. Rather, any use of “first” and “second” within the Summary, Detailed Description, and/or claims may be used to distinguish between two different instances of the same element.

In closing, although the various techniques have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

What is claimed is:

1. A method comprising:
overwriting a portion of a function with instructions that redirect execution to a revised version of the function, wherein the function is included in an executable module;
identifying a plurality of threads executing within a process that has loaded the executable module;
pausing execution of the plurality of threads;
analyzing a plurality of call stacks of the plurality of threads to determine that the function is not being executed by the plurality of threads;
analyzing the plurality of call stacks of the plurality of threads to determine that the plurality of threads are not scheduled to return to and resume execution of the function; and
rendering a function body of the function inoperable.

2. The method of claim 1, wherein the plurality of threads are iteratively paused and the plurality of call stacks are iteratively analyzed until the plurality of threads have returned from the function and the plurality of threads are no longer scheduled to return to and resume execution of the function.

3. The method of claim 2, wherein a thread of the plurality of threads that has returned from the function and that no longer is scheduled to return to and execute within the function is removed from the plurality of threads.

4. The method of claim 1, wherein the executable module is shared by a plurality of processes, the method further comprising:
making a copy of the executable module in physical memory that is accessible to one of the plurality of processes, wherein rendering the function body inoperable comprises rendering the function body inoperable in the copy of the executable module.

5. The method of claim 1, wherein the executable module is shared by a plurality of processes, the method further comprising:
making a copy of a page of memory of the function body in physical memory that is accessible to one of the plurality of processes, wherein rendering the function body inoperable comprises rendering the page of memory inoperable.

6. The method of claim 1, wherein determining that one of the plurality of threads is scheduled to return to and resume execution of the function by identifying a stack frame of the function that is underneath a top stack frame.

7. The method of claim 1, wherein the plurality of threads are identified from a plurality of processes.

8. The method of claim 1, further comprising:
identifying a plurality of dependent threads of the plurality of threads that are executing or are scheduled to return to and resume executing the function;
identifying a portion of the function body that is unreachable by the plurality of dependent threads; and
rendering the portion of the function body inoperable.

9. The method of claim 1, wherein the plurality of threads are iteratively paused and the plurality of call stacks are iteratively analyzed until a defined period of time or a defined number of pauses have occurred.

10. The method of claim 9, further comprising:
sending an alert indicating that vulnerable code of a patched function could not be safely rendered inoperable.

11. A system comprising:
a processing unit; and
a computer-readable storage medium having computer-executable instructions stored thereupon that, when executed by the processing unit, cause the processing unit to:
overwrite a portion of a function with instructions that redirect execution to a patched version of the function;
store a record of a first plurality of threads executing within a first plurality of processes that have loaded the function;
iteratively enumerate a second plurality of threads executing within the first plurality of processes that have loaded the function until the first plurality of threads have exited or the first plurality of processes have exited; and
render at least a portion of a function body of the function inoperable.

12. The system of claim 11, wherein new invocations of the function are redirected to the patched version of the function.

13. The system of claim 11, wherein the computer-executable instructions further cause the processing unit to:
identify a feature of an application or operating system that causes the function to remain active; and
disabling the feature.

14. A computer-readable storage device having encoded thereon computer-readable instructions that when executed by a processing unit causes a system to:
overwrite a portion of a function with instructions that redirect execution to a revised version of the function, wherein the function is instrumented with:
an entry counter that increments a count when a thread enters the function;
an exit counter that decrements the count when the thread exits the function;
determine that the count equals zero; and
render a function body of the function inoperable.

15. The computer-readable storage device of claim 14, wherein the function is instrumented by a compiler of the function by inserting the entry counter at an entry point of the function and inserting the exit counter before an instruction that exits the function.

16. The computer-readable storage device of claim 14, wherein the function is instrumented with the entrance counter at runtime by placing a pointer to the entrance counter in a patch prologue of the revised version of the function, and wherein the function is instrumented with the exit counter at runtime by, for each invocation of the function, overwriting a return address with a pointer to the exit counter.

17. The computer-readable storage device of claim 14, wherein the function body is rendered inoperable by overwriting the function body with no-operation instructions.

18. The computer-readable storage device of claim 14, wherein the function body is rendered inoperable by overwriting the function body with instructions that throw an exception.

19. The computer-readable storage device of claim 18, wherein the computer-readable instructions further cause the processing unit to:
detect an exception thrown by an instruction written to the function body; and
apply a security disruption operation to an application associated with the plurality of threads.

20. The computer-readable storage device of claim 14, wherein the function body is rendered inoperable by marking at least one page of memory that stores the function body as non-executable.
